(19) United States
(12) Patent Application Publication
(10) Pub. No.: US 2016/0131891 A1
(43) Pub. Date: May 12, 2016

(54) IMAGE PROCESSING METHOD, IMAGE PROCESSING APPARATUS, IMAGE PICKUP APPARATUS, AND NON-TRANSITORY COMPUTER-READABLE STORAGE MEDIUM

(71) Applicant: CANON KABUSHIKI KAISHA, Ohta-ku, Tokyo (JP)

(72) Inventor: Yoshinari Higaki, Kawasaki-shi (JP)

(21) Appl. No.: 14/897,427

(22) PCT Filed: Jul. 16, 2014
(86) PCT No.: PCT/JP2014/069499

§ 371 Date: Dec. 10, 2015

(30) Foreign Application Priority Data
Sep. 6, 2013 (JP) 2013-184545

(51) Int. Cl. G02B 21/36; G06T 5/00; G06T 5/50

(52) U.S. Cl. CPC G02B 21/367; G06T 5/50; G06T 5/009; G06T 2207/10056; G06T 2207/20208; G06T 2207/20216; G06T 2207/20076

(57) ABSTRACT

An image processing apparatus includes a first calculator configured to calculate combination coefficients through a linear combination of a basis generated from a plurality of first images that are obtained by photoelectrically converting optical images of a plurality of known first samples formed by a partially coherent or coherent imaging optical system, the combination coefficients being used to approximate a second image, a second calculator configured to calculate intermediate data based on a plurality of complex quantity data obtained by a non-linear mapping of data of the first samples and the combination coefficients calculated by the first calculator, and a third calculator configured to calculate complex quantity data of an unknown second sample based on the intermediate data calculated by the second calculator.

### TECHNICAL FIELD

The present invention relates to an image processing method, an image processing apparatus, an image pickup apparatus, and a non-transitory computer-readable storage medium for processing on a sample image captured through a partially coherent or coherent imaging optical system.

### BACKGROUND ART

Conventionally, a phase contrast microscope and a differential interference contrast microscope used to observe a sample in the biology and pathological diagnosis have had difficulties in obtaining quantitative information on changes in the intensity and phase of transmitted light, which is necessary to understand details of the internal structure of the sample. One major cause is a non-linearity in an observation process between the amplitude and phase distribution of the sample transmitted light and an image, and it is difficult to solve an inverse problem. The inverse problem, as used herein, means a problem of numerically estimating an original signal (sample information) from observed data (image), and a reconstruction, as used herein, means solving the inverse problem.

A variety of methods of quantifying phase information of the sample has recently been proposed, such as an interference method (PTL1) using a digital holography microscope and a method that illuminates the sample with a laser beam and acquires a plurality of images through an optical system including a spatial light modulator (SLM) (NPL 1). A typical interference method observes a light intensity distribution formed on an image plane as a result of interference between reference light not passing through the sample and object light passing through the sample, calculates acquired image data, and reconstructs sample information. The method of illuminating the sample with a laser beam and of directly capturing the object light does not require the reference light, but calculates a plurality of image data acquired at different defocus states and reconstructs sample information.

One new calculation method of solving an inverse problem of a non-linear model is so-called kernel compressive sensing (simply referred to as “KCS” hereinafter) (NPL 2). Compressive sensing (simply referred to as “CS” hereinafter) is a method for significantly reducing an observed data amount for a linear observation process. The KCS further reduces the observed data amount where a sparse representation is assumed by performing an appropriate non-linear mapping of data. However, the KCS does not cover the non-linear observation process, and is inapplicable directly to the above inverse problem of the microscope. A method of solving an inverse problem of a normal bright field microscope (partially coherent imaging) by utilizing the concept of the compressive sensing is disclosed in NPL 3. NPL 4 describes a general definition of the kernel method.

### CITATION LIST

### Patent Literature

[PTL 1] Japanese Patent No. 4772961

### Non Patent Literature

[NPL 1] Vladimir Katkovnik and Jaakko Astola, “Phase retrieval via spatial light modulator phase modulation in 4f optical setup: numerical inverse imaging with sparse regularization for phase and amplitude,” Journal of the Optical Society of America A, U.S.A., Optical Society of America, 2012, Vol. 29(1), pp. 105-116
[NPL 2] Karthikeyan Natesan Ramamurthy and Andreas Spanias, “Optimized Measurements for Kernel Compressive Sensing,” Proceedings of Asilomar Conference on Signals, Systems, and Computers, U.S.A., 2011, pp. 1443-1446
[NPL 3] Y. Shechtman, Y. C. Eldar, A. Szameit, and M. Segev, “Sparsity based sub-wavelength imaging with partially incoherent light via quadratic compressed sensing,” Optics Express, U.S.A., Optical Society of America, 2011, Vol. 19, pp. 14807-14822
[NPL 4] John Shawe-Taylor, Nello Cristianini, “Kernel Methods for Pattern Analysis,” Cambridge University Press, U.S.A., 2004

### SUMMARY OF INVENTION

### Technical Problem

The interference method requires a highly accurate adjustment because optical interference is sensitive to environmental changes, and observation data is prone to noises. In addition, two optical paths for the reference light and the object light are likely to make complicate an apparatus and to increase the cost. Since the method of illuminating the sample with the laser beam to capture an image requires an accurate defocus control to acquire a plurality of images, a mechanical controller and a large data amount increase an apparatus cost and data processing time. Since the method requires a coherent illumination that illuminates the sample with the laser beam, speckle noises are generated. Inserting a speckle reducing diffusion plate into the optical path leads to a degraded resolving power. Both methods share the following two problems: One is a high calculation cost for iterative processing required in the reconstruction calculation for the sample information, and the other is the incapability of a normal microscopy observation using the same apparatus configuration. The method disclosed in NPL 3 has the following two problems: One is the applicability only to a sample having a sufficiently sparse amplitude due to a binary phase, and the other is a high calculation cost like the other method described above.

### Solution to Problem

The present invention provides an image processing method, an image processing apparatus, an image pickup apparatus, and a non-transitory computer-readable storage medium that can quickly and highly accurately reconstruct an amplitude and phase distribution of sample transmitted light based on an image obtained through a bright field microscope.

An image processing apparatus according to the present invention includes a first calculator configured to calculate combination coefficients through a linear combination of a basis generated from a plurality of first images that are obtained by photoelectrically converting optical images of a plurality of known first samples formed by a partially coherent or coherent imaging optical system, the combination coefficients being used to approximate a second image, a second calculator configured to calculate intermediate data based on a plurality of complex quantity data obtained by a non-linear mapping of data of the first samples and the combination coefficients calculated by the first calculator, and a third calculator configured to calculate complex quantity data of an unknown second sample based on the intermediate data calculated by the second calculator.

### Advantageous Effects of Invention

The present invention provides an image processing method, an image processing apparatus, an image pickup apparatus, and a non-transitory computer-readable storage medium that can quickly and highly accurately reconstruct an amplitude and phase distribution of sample transmitted light based on an image obtained through a bright field microscope.

### BRIEF DESCRIPTION OF DRAWINGS

FIG. 1 is a block diagram of an image pickup apparatus according to this embodiment of the present invention.

FIG. 2 is a conceptual diagram of image processing according to the embodiment.

FIGS. 3A to 3C are flowcharts for explaining the image processing according to the embodiment.

FIGS. 4A to 4C illustrate an illumination and an optical element used in a simulation according to the embodiment.

FIGS. 5A to 5D illustrate training data according to a first embodiment of the present invention.

FIGS. 6A to 6C illustrate true amplitude and phase distributions and an evaluation image according to a first embodiment of the present invention.

FIGS. 7A and 7B illustrate reconstructed amplitude and phase distribution according to a first embodiment of the present invention.

FIG. 8 illustrates an evaluation image according to a second embodiment of the present invention.

FIGS. 9A to 9D illustrate reconstructed amplitude and phase distribution according to a second embodiment of the present invention.

FIGS. 10A to 10C illustrate true amplitude and phase distributions and an evaluation image according to a third embodiment of the present invention.

FIGS. 11A and 11B illustrate reconstructed amplitude and phase distribution according to a third embodiment of the present invention.

FIGS. 12A to 12D illustrate reconstruction results when a process illustrated in FIG. 3C is executed according to a third embodiment.

FIGS. 13A and 13B illustrate reconstructed amplitude and phase distribution according to a third embodiment of the present invention.

### DESCRIPTION OF EMBODIMENTS

The present invention relates an image pickup apparatus, and more particularly to a system for reconstructing sample information based on a digital image acquired through a bright field microscope. An image processor (image processing apparatus) according to this embodiment of the present invention includes a storage, a combination coefficient calculator (first calculator), an intermediate data generator (second calculator), a converter (third calculator), and a determiner. In particular, the image processor is characterized in that the combination coefficient calculator approximates an evaluation image by a linear combination of a basis and that the intermediate data generator and the converter output complex quantity data. Such an image pickup apparatus or an image pickup system is suitable for a digital microscope and useful in, for example, the medical and biological research and pathology diagnosis.

Exemplary embodiments of the present invention will be described below with reference to the accompanying drawings.

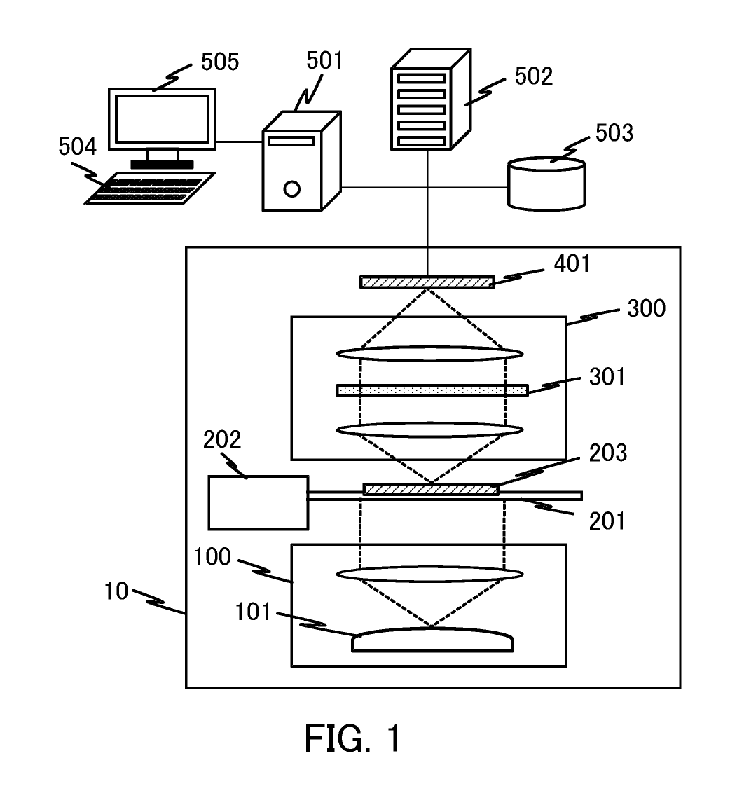

FIG. 1 illustrates a schematic configuration of an image pickup system according to this embodiment of the present invention. As illustrated in FIG. 1, the image pickup system according to the embodiment includes an image pickup apparatus 10, a computer (“PC”) 501, an image processor (image processing apparatus) 502, and a storage 503. The PC 501 is connected to an input device 504 and a display 505. The configuration of the system in FIG. 1 is merely an example.

The image pickup apparatus 10 includes an illumination optical system 100, a light source 101, a sample stage 201, a stage driver 202, an imaging optical system 300, an optical element 301, and an image sensor 401.

The light source 101 may be, for example, a halogen lamp or a light emitting diode (LED).

The illumination optical system 100 may include an illumination light modulation apparatus such as an aperture diaphragm. In an optical system of the bright field microscope, the aperture diaphragm in the illumination optical system 100 changes a resolving power and a depth of focus. This makes the illumination light modulation apparatus useful for adjusting an observation image in accordance with kinds of the sample and needs of a user. The illumination light modulation apparatus may be used to improve a reconstruction accuracy to be described later. For example, when used as the illumination light modulation apparatus, an aperture diaphragm having a small numerical aperture or a mask having a complicated transmissivity distribution degrades the resolving power of the sample in the observation image. They are useful, however, if the reconstruction accuracy improves as compared to a case of not using the illumination light modulation apparatus.

Light emitted from the illumination optical system 100 is guided to a sample 203 placed on the sample stage 201. The stage driver 202 serves to move the sample stage 201 in an optical axis direction of the imaging optical system 300 and a direction orthogonal to the optical axis, and may serve to replace the sample. The sample may be replaced automatically by another mechanism (not illustrated) or manually by the user.

Information to identify the sample 203 includes the amplitude and phase distribution of the transmitted light. The amplitude and phase distribution means the amplitude and two-dimensional phase distribution of the transmitted light right just after the sample 203 onto which parallel light is irradiated (typically in a direction perpendicular to a surface of the sample), and hereinafter simply referred to as the “amplitude distribution” and “phase distribution” of the sample 203.

This may be generalized to a two-dimensional distribution in complex quantities reflecting the structure of the sample 203. For example, the sample 203 has a low transmissivity in a densely stained portion or in a portion significantly scattering light, and the amplitude of the transmitted light decays as compared to that of an incident light. The sample 203 has a relatively long optical path length in a portion having a relatively high refractive index, resulting in a relatively large phase change amount for the incident light. The “optical path length” corresponds to a product of a refractive index of a light passing medium and the thickness of the medium, and is proportional to the phase change amount of the transmitted light. As described above, the amplitude and phase distribution of the transmitted light of the sample 203 reflect the structure of the sample 203, and therefore they allow a three-dimensional structure of the sample 203 to be estimated.

The transmitted light through the sample 203 forms, on the image sensor 401, an optical image of the sample 203 through the imaging optical system 300. The optical element 301 disposed on an optical path of the imaging optical system 300 modulates distribution of at least one of the intensity and phase of projection light near a pupil plane of the imaging optical system 300. The optical element 301 is disposed so as to effectively embed information of the amplitude or phase distribution of the sample as a reconstruction target into the observation image. In other words, the optical element 301 is disposed so as to minimize the number of images to be acquired or the resolution and to realize a highly accurate reconstruction of the amplitude or phase distribution of the sample. The optical element 301 may be a variably modulating element such as an SLM or may be an element such as a phase plate having a fixed optical property. Alternatively, the optical element 301 may have a movable structure that is installable on and removable from the optical path.

The optical property of the optical element 301 is affected by manufacturing errors and control errors, and it is concerned that the reconstruction result is affected. However, as described for the step S213, this problem can be solved when the optical property is previously measured or the sample data of a training sample is perfectly known. The configuration of the optical system may not be necessarily a transmissive type that images the transmitted light through the sample, but may be of an epi-illumination type.

The image sensor 401 photoelectrically converts the optical image of the sample 203 projected by the imaging optical system 300, and transmits the converted image as image data to any one of the computer (PC) 501, the image processor 502, and the storage 503.

If the sample 203 is not reconstructed just after the image is acquired, the image data is transmitted from the image sensor 401 to the PC 501 or the storage 503 for storage purposes. If the reconstruction follows just after the image is acquired, the image data is transmitted to the image processor 502 and arithmetic processing for the reconstruction is performed.

The image processor 502 includes the storage, the combination coefficient calculator (first calculator), the intermediate data generator (second calculator), the converter (third calculator), and the determiner. Each component is configured as an individual module by hardware or software. Although controlled by the PC 501, the image processor 502 may include a microcomputer (processor) like the image processing apparatus.

The combination coefficient calculator calculates combination coefficients used to approximate a second image by a linear combination of a basis generated from a plurality of images obtained by photoelectrically converting optical images of a plurality of known samples formed by the imaging optical system 300. The intermediate data generator calculates intermediate data based on a plurality of complex quantity data obtained by a non-linear mapping of data of the known samples and the calculated combination coefficients. The converter calculates the complex quantity data of an unknown sample from the calculated intermediate data. The determiner determines, based on the calculated combination coefficients, whether to replace training data used for the reconstruction and whether to restart the reconstruction.

Generated data is displayed on the display 505 and/or transmitted to the PC 501 or the storage 503 for storage purposes. The content of this processing is determined based on an instruction from the user through the input device 504 or information stored in the PC 501 or the storage 503.

All apparatuses other than the image pickup apparatus 10 in FIG. 1 are not necessarily connected physically and directly to the image pickup apparatus 10. For example, they may be connected to the image pickup apparatus 10 externally through a local area network (LAN) or a cloud service. This characteristic can reduce a cost and size of the image pickup apparatus 10 since the image pickup apparatus 10 is not integrated with the image processor 502 and data can be shared among a plurality of users on a real-time basis.

A description will now be given of a method of reconstructing information of the sample 203 according to the various embodiments of the present invention.

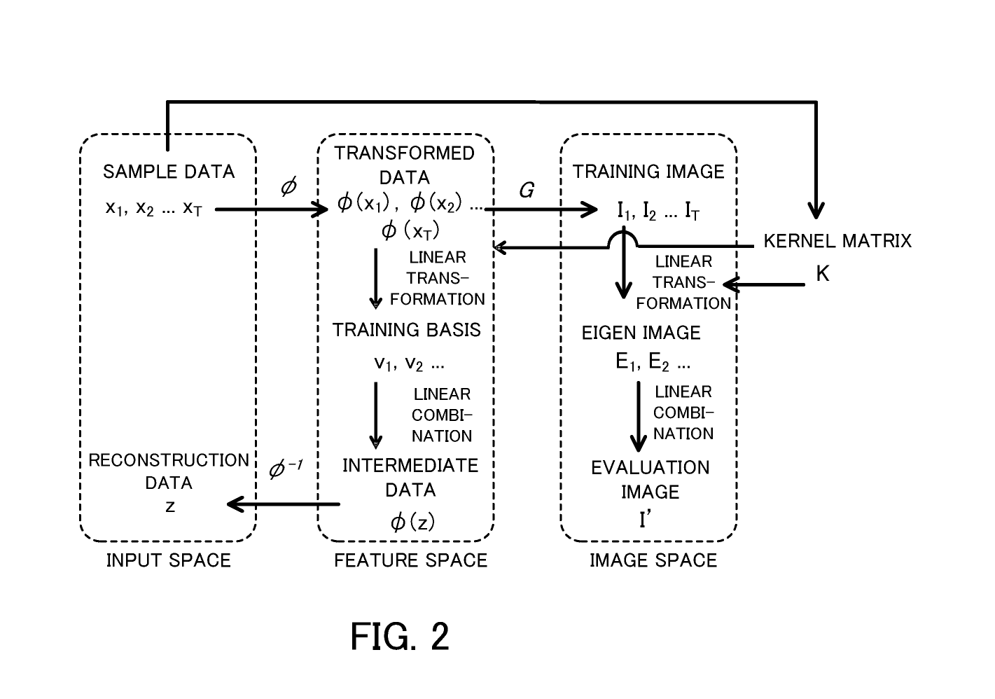

The present invention discloses a unit for reconstructing, by using the training data, the amplitude and phase distribution of the unknown sample 203 from an evaluation image acquired through the image pickup apparatus. Prior to a description of the reconstruction method, a concept of image processing according to the present embodiment will be described with reference to FIG. 2.

The image processing illustrated in FIG. 2 may be performed by an isolated image processing apparatus or by the image processor 502 integrated with the image pickup apparatus 10. The reconstruction method illustrated in FIG. 2 serves as an image processing method.

First, the training data will be described. A plurality of samples (first samples) 203 each having the known amplitude and phase distribution are referred to as “training samples,” and the amplitude and phase distributions of the training samples are used for the reconstruction. In this embodiment, T denotes the number of training samples. The amplitude and phase distributions of the T training samples are referred to as “sample data,” and the amplitude and phase distribution of an unknown sample (second sample) are referred to as “reconstruction data.” T observation images (first images) obtained through the image pickup apparatus from the respective T training samples are referred to as “training images,” and one observation image (second image) obtained similarly from the unknown sample is referred to as an “evaluation image.” The training samples and the training images are collectively referred to as the “training data.”

The first images of the first samples are obtained by photoelectrically converting the optical images of the known first samples formed by a partially coherent or coherent imaging optical system. More specifically, the first images are obtained by photoelectrically converting the optical images of the known first samples formed by the imaging optical system or another imaging optical system having an optical property equivalent to that of the imaging optical system. Alternatively, the first images may be calculationally generated based on the complex quantity data corresponding to the respective first samples.

Similarly, the second image is obtained by photoelectrically converting the optical image of the unknown second sample formed by the imaging optical system or another imaging optical system having an optical property equivalent to that of the imaging optical system.

Since this embodiment assumes use of the bright field microscope, the observation image of the sample 203 is formed by coherent imaging or partially coherent imaging. For example, as disclosed in NPL 3, there is a non-linear relationship between the amplitude and phase distribution of the sample 203 and the observation image in this case. More specifically, a vector I representing the observation image and a vector x representing the amplitude and phase distribution of the sample satisfy a relationship expressed by Expression (1).

I=G·vec(xx^{H})=G·kron(x,x*) (1)

Herein, x is a column vector representing the amplitude and phase distribution of the sample 203 in complex numbers, G is a complex matrix expressing the partially coherent imaging or the coherent imaging, vec is a calculation for separating a matrix into column vectors and joining them longitudinally, and H is conjugate transpose of a vector. In addition, kron is a Kronecker product and * on the right shoulder is a complex conjugate. The matrix G contains, in addition to information of optical blur caused by a diffraction limit of the imaging optical system 300, all information of image degrading factors such as the aberration and defocus of the imaging optical system 300, information of the optical element 301, vibrations and a temperature change caused by the image pickup apparatus itself or its environment.

Although not explicitly indicated in Expression (1), an observation noise is caused by the image sensor 401 and the like is present in an actual observation process. This will be expressed by an additional real constant vector representing the noise on the right side of Expression (1).

Next, three spaces of an input space, a feature space, and an image space illustrated in FIG. 2 are defined.

The “input space” is a space spanned by data about the amplitude and phase distribution of the sample 203 where each data is an N-dimensional complex vector. The input space includes the sample data and the reconstruction data. These pieces of data are expressed as complex numbers made by sampling amplitude and phase values at N known coordinates in a plane substantially parallel to the sample surface.

The “feature space” is a space spanned by data obtained through a non-linear mapping φ on data in the input space, where the non-linear mapping φ is defined by Expression (2) based on Expression (1).

φ(x)=vec(xx^{H})=kron(x,x*) (2)

This mapping converts an N-dimensional complex vector in the input space into an N²-dimensional complex vector in the feature space. By introducing the non-linear mapping φ, the coherent imaging or the partially coherent imaging expressed by Expression (1) can be understood as a linear mapping on data in the feature space. Since this linear mapping is a conversion involving a multiplication by the matrix G as expressed in Expression (1), this linear mapping will be referred to as G hereinafter.

One characteristic of this embodiment is to separate non-linearity causing the major difficulty in solving an inverse problem in the coherent imaging or the partially coherent imaging, into the non-linear mapping and the linear mapping. Hereinafter, as illustrated in FIG. 2, the sample data mapped onto the feature space is referred to as “transformed data,” and the reconstruction data mapped onto the feature space is referred to as “intermediate data.”

In addition, φ⁻¹ illustrated in FIG. 2 is an inverse mapping of φ such that data mapped by φ is mapped back to the original data by φ⁻¹. However, φ⁻¹ cannot be expressed for φ of Expression (2), and thus a result of φ⁻¹ can be obtained only through a numerical estimation. One concrete method of the numerical estimation is a singular value decomposition (SVD) of a matrix. In this embodiment, since all data in the feature space is a square matrix of rank 1, the singular value decomposition on such a matrix uniquely provides an N-dimensional vector x as a singular vector. In other words, φ⁻¹ can be defined as an operation of the singular value decomposition to output the singular vector.

The “image space” is a space spanned by data obtained by mapping data in the feature space by the linear mapping G, that is, a space spanned by observation images. As illustrated in FIG. 2, a mapping of the transformed data by G is the training image, and a mapping of the intermediate data by G is the evaluation image. Each piece of data in the image space is data obtained by sampling actually observed image intensity distribution at M predetermined points, and is an M-dimensional real vector.

Next, a kernel matrix will be defined. Recently, in a field of machine learning, a so-called kernel method has been used for learning purposes based on a non-linear model. A general idea of the kernel method is discussed, for example, in NPL 4. Typically in the kernel method, a kernel matrix K is defined by Expression (3) using an appropriate non-linear mapping φ′.

Kᵢⱼ= [symbol] φ′(Xᵢ),φ(Xⱼ) [symbol] (3)

Herein, Kᵢⱼ is a component of an i-th row and j-th column of the kernel matrix K, Xᵢ is data corresponding to an i-th sample in a sample population, and <•, •> represents an inner product. If the inner product is regarded as a similarity between two data, the kernel matrix K can be understood as a matrix expressing similarities between all combinations of data in the feature space. When the non-linear mapping φ′ of Expression (3) is replaced with the non-linear mapping φ of Expression (2), the kernel matrix K is expressed without φ as expressed in Expression (4).

Kᵢⱼ−|xⱼ^{H}xᵢ|² (4)

Herein, xᵢ is a complex vector representing the sample data of an i-th training sample. In order to calculate the kernel matrix K, the inner product between two N²-dimensional vectors is calculated after data in the input space is mapped to the feature space in Expression (3), whereas only the inner product between two N-dimensional vectors in the input space needs to be calculated in Expression (4). Therefore, Expression (4) can significantly reduce a calculation amount as compared to that of Expression (3). This method of reducing the calculation amount of the kernel matrix is generally called a kernel trick.

It is another characteristic of the present invention to apply the kernel method not to the machine learning but to the inverse problem of the coherent imaging or partially coherent imaging. It is still another characteristic of the present invention is characterized to use the kernel in Expression (4) because the calculation amount can be reduced.

(Centering) processing of removing an average value may be performed on φ′ (X) in Expression (3), and the post-centering kernel matrix K can be calculated directly from the kernel matrix K as disclosed in NPL 4.

Next, a relationship between the training images and the evaluation image is extracted based on the kernel matrix K. This relationship is equivalent to a relationship between the transformed data and the intermediate data in the feature space. This is because the feature space and the image space correspond to each other through the linear mapping G.

In order to extract the relationship, a new basis is generated by a linear combination of a plurality of training images. This new basis consists of a plurality of eigen images. A concrete method of generating the basis includes, for example, performing a principal component analysis for the kernel matrix K, linearly combining the training images with one another by using a plurality of obtained eigenvectors as linear combination coefficients, and generating a plurality of eigen images. This can be expressed in Expression (5):

E=Iα (5)

Herein, E is an M×L matrix whose columns are eigen images E₁, E₂, . . . E_{L}, and I is an M×T matrix whose columns are training images I₁, I₂, . . . I_{T}. L is a positive natural number equal to or less than the rank of the kernel matrix K, and may be designated by the user or determined based on eigenvalues of the kernel matrix K. The latter case includes, but is not limited to, a determination method of automatically setting to L, the number of the eigenvalues equal to or greater than a predetermined threshold. α is a T×L matrix constituted by a plurality of eigenvectors of the kernel matrix K. One concrete method of calculating the matrix α may use a singular value decomposition of the kernel matrix K, for example. In this case, L singular vectors are selected in a descending order of the corresponding singular values or in accordance with any other criteria, and these column vectors are joined together into the matrix α.

Next, the L eigen images are linearly combined to approximate the evaluation image, thereby completely determining the relationship between the training images and the evaluation image. In other words, a solution closest to the evaluation image is searched in an L-dimensional space in which the eigen images are used for the basis. The approximation can be formulated as, for example, a problem of solving combination coefficients that minimize the norm of a difference between a linear combination of the eigen images and the evaluation image, that is, a least squares problem. When the combination coefficients are expressed as an L-dimensional real vector γ, the least squares problem can be expressed in Expression (6).

$$\hat{γ} = {argmin}_{γ} {‖ {I}^{′} - E γ ‖}_{2} + λ {‖ γ ‖}_{2} \qquad ( 6 )$$

Herein, a hat (̂) above γ means an estimated solution. The second term on the right side of Expression (6) is a kind of regularization term added to avoid an abnormal value of the solution. In particular, as in Expression (6), a regularization defined by the L2 norm of the solution (least squares solution) is called a Tikhonov regularization or ridge regression. The coefficient λ of the regularization term is an arbitrary real number. The first calculator may estimate the magnitude of the observation noise included in the evaluation image and determine the regularization coefficient λ based on the estimated magnitude. The regularization coefficient λ may be set to 0 so as not to perform the regularization. In this case, the first calculator can calculate the least squares solution by using a Moore-Penrose pseudo inverse matrix of a matrix constituted by a basis and calculate the combination coefficients.

Where the regularization coefficient λ is non-0, the solution of Expression (6) is given by Expression (7) as disclosed in NPL 4, and can be calculated relatively quickly without iterative processing. Expression (7) has either of expressions below, depending on whether the matrix E is tall or wide.

$$γ = \{ \begin{matrix}{( {E}^{T} E + λ L )}^{- 1} {E}^{T} {I}^{′} & ( L \leq M ) \\ {{E}^{T} ( {EE}^{T} + λ L )}^{- 1} {I}^{′} & ( L > M )\end{matrix} \qquad ( 7 )$$

Herein, T on the right shoulder is a transpose of a matrix, −1 on the right shoulder is an inverse matrix, a matrix L is an L-dimensional unit matrix, and a vector I′ is the evaluation image. The method of calculating the solution of Expression (6) is not limited to Expression (7) and may employ, for example, Expression (8) instead.

\hat{γ}=VΣ′V^{H}

E=U_{L}ΣU_{R}^{H}

Σ′=threshold(Σ⁻¹,θ) (8)

Herein, U_{L} and U_{R} are matrices each constituted by singular vectors of E, Σ is a diagonal matrix whose diagonal elements are singular values of E, and “threshold” is a function that replaces any matrix element, among matrix elements as arguments, exceeding a threshold θ with a constant such as 0. As described above, based on Expressions (5) and (6), the evaluation image I′ is approximated by multiplying the matrix I corresponding to the T training images by the matrix α and the vector γ. This is the relationship between the training images and the evaluation image. When this relationship is applied to the feature space, the intermediate data φ(z) is obtained by multiplying a matrix Φ having T transformed data as column elements by the matrix α and the vector γ. This relationship can be expressed in Expression (9).

φ(z)=Φαγ=vγ (9)

Herein, the matrix Φ is an N²×T matrix whose columns are φ(x₁), φ(x₂), . . . φ(x_{T}), respectively, and V is an N²×L matrix whose columns are the training bases v₁, v₂, . . . v_{L}. As illustrated in FIG. 2, training basis is a set of L vectors corresponding to the eigen images in the feature space and form the intermediate data. The training basis is a concept introduced for description convenience and therefore not needed to be explicitly calculated in the embodiment.

It is thus one characteristic of the present embodiment is to avoid a direct calculation of inverse mapping of the linear mapping G. Since the dimension N² of the feature space is significantly greater than the dimension M of the image space, the inverse mapping of the linear mapping G is not uniquely determined and thus the inverse problem under this condition belongs to what is called an ill-posed problem.

In contrast, the method according to the present invention involves no calculation including such an inappropriateness and thus can stably obtain a correct reconstruction result. In addition, as described above, inverse mapping of data in the feature space onto the input space can be performed by the singular value decomposition or the like, and as a result, the reconstruction data z is uniquely calculated from the intermediate data φ(z). In summary, through sequential calculations of Expressions (5), (6), and (9), the reconstruction data z can be reconstructed from known training data and evaluation image.

It is another aspect of the present invention to a fast reconstruction in the coherent imaging or the partially coherent imaging by calculating matrix products without iterative processing. In addition, the present invention is characterized in a process of the reconstruction illustrated in FIG. 2 from the evaluation image I′, not directly to the intermediate data φ(z) or the reconstruction data z but via the training data without the inverse mapping of the linear mapping G.

Although the typical CS assumes sparse information as a reconstruction target, the present invention is characterized in that it does not assume the sparsity as understood from the above description and therefore is capable of reconstructing non-sparse information in principle.

In this regard, NPL 2 discloses no idea of applying a relationship between physical observation amounts (observation images) directly to the feature space, and thus is essentially different from the present invention.

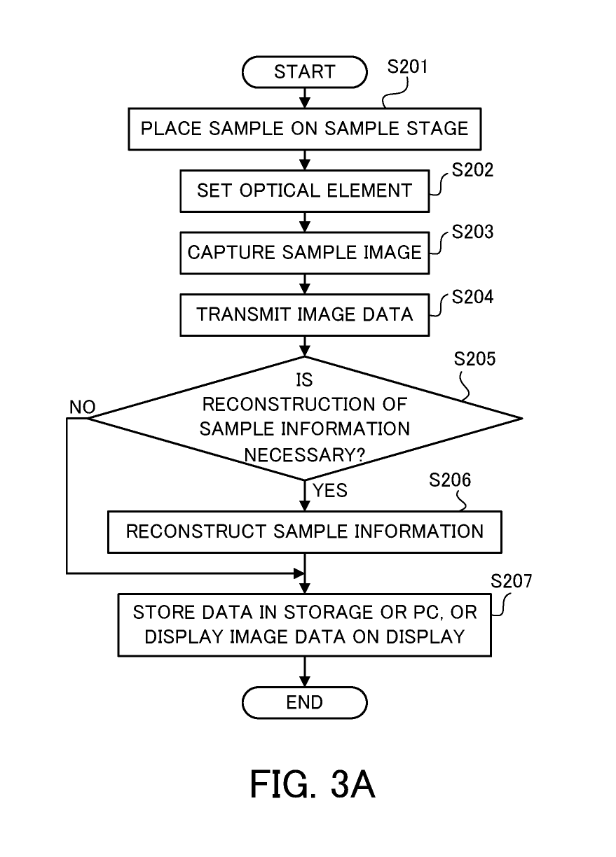

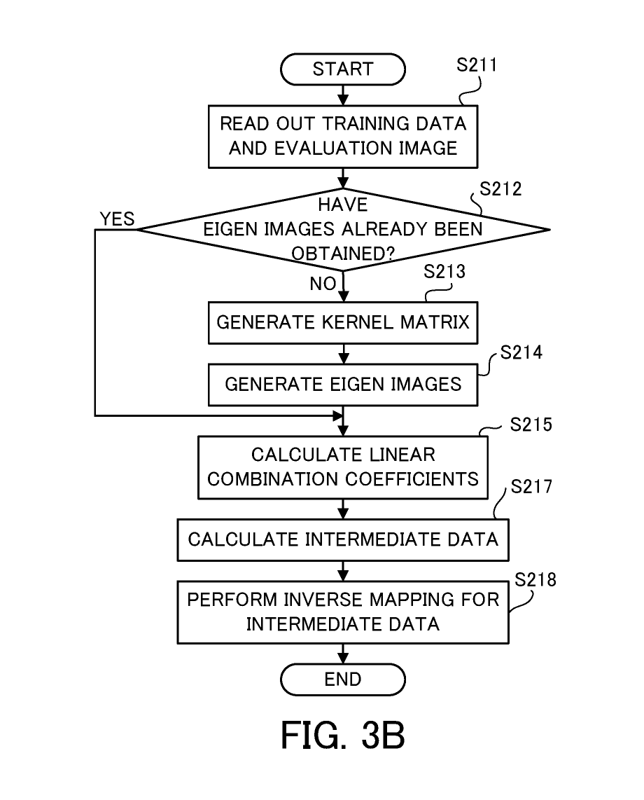

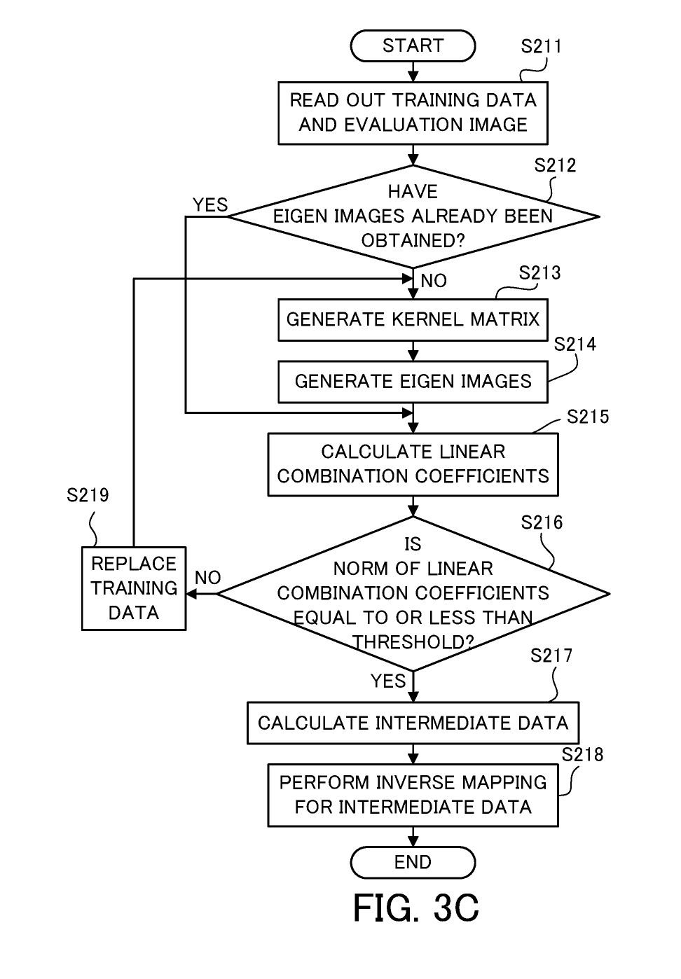

Next follows a description of an image processing method for reconstructing information of the sample 203 in the image pickup system illustrated in FIG. 1 with reference to FIGS. 3A-3C. “S” stands for the step, and flowcharts illustrated in FIGS. 3A-3C can be implemented as a program that enables a computer to implement a function of each step. First, the procedure of the whole processing will be described with reference to the flowchart illustrated in FIG. 3A.

At S201, the sample 203 is placed on the sample stage 201. For example, the sample stage 201 itself or an associative automatic feed mechanism takes out the sample 203 from a sample holder such as a cassette and places it on the sample stage 201. This processing may be manually performed by the user instead of an automatic operation by the apparatus. The stage driver 202 controls driving of the sample stage 201 and moves the sample 203 to a position appropriate for capturing an image of an observation target region of the sample 203 in a predetermined in-focus state. This movement may be performed at any timing before S203.

At S202, in reconstructing information of the sample 203, the optical element 301 modulates the distribution of at least one of the intensity and phase of projected light as necessary. In acquiring a normal microscope image, any modulations to the intensity and phase of the projected light are prevented by retreating the optical element 301 from the optical path or by controlling the SLM, for example.

At S203, an image of the sample 203 whose amplitude and phase distribution are unknown is captured.

At S204, image data acquired at S203 is transmitted from the image sensor 401 to any one of the PC 501, the image processor 502, and the storage 503.

In reconstructing information of the sample 203, processing at S206 is performed.

At S206, the image processor 502 outputs, based on the image data, the reconstruction data of the amplitude or phase distribution of the sample. This processing will be described in detail with reference to FIG. 3B later.

At S207, in accordance with an instruction from the user or a predetermined setting, the reconstruction data is stored in one of the storage 503 and the PC 501, or is displayed on the display 505.

Next follows a description of the image processing performed at S206 by the image processor 502 with reference to the flowchart illustrated in FIG. 3B.

At S211, the training data stored in one of the PC 501 and the storage 503 and the evaluation image for the unknown sample are read out. The number of pairs between the sample and the evaluation image may be one or more.

The training data is previously acquired and stored prior to a series of processing illustrated in FIG. 3A. The training data may be generated by calculation only when any factors affecting the relationship between the sample 203 and the observation image in the image pickup apparatus 10 are known, such as aberration information of the imaging optical system 300, a defocus amount, and information of the intensity and phase distribution modulated by the optical element 301. That is, T sample data are generated by calculations in accordance with predetermined rules, and the training images are generated by calculations through an imaging simulation based on the sample data and information of the image pickup apparatus 10.

The information of the image pickup apparatus 10 may be acquired by measurements on the image pickup apparatus 10 before the training data is generated. For example, a general wavefront aberration measuring method is applied to the image pickup apparatus 10 to acquire aberration data for use in the imaging simulation.

The reconstruction may be performed while the information of the image pickup apparatus 10 is maintained unknown. In this case, the training samples are set to a plurality of existent samples 203, the image pickup apparatus 10 is used with these samples 203, the training images are acquired under the same conditions and procedures as those in FIG. 3A.

In that case, the sample data about all the training samples, that is, the amplitude and phase distribution of the transmitted light need to be known. The sample data may be generated from data obtained by the general wavefront aberration measuring method or a surface shape measuring method, or generated based on a design value if the samples are artificial. A plurality of training samples are not necessary in appearance. For example, a plurality of elements effective as training samples may be integrated into one sample, but the present invention is not limited to this example.

It is thus another characteristic of the present invention to solve the inverse problem even when the information of the image pickup apparatus 10 is unknown or to provide a blind estimation. The blind estimation is advantageous in robustness of the reconstruction accuracy against various kinds of image degrading factors.

Examples of the image degrading factors include performance scattering due to manufacturing errors of the image pickup apparatus 10 and the optical element 301, and vibrations and temperature changes caused by the image pickup apparatus itself or the environment. The blind estimation is feasible because the training data including the relationship between the sample 203 and the observation image is used to avoid the matrix G in Expression (1) containing all the information of the image pickup apparatus 10 from being used for the reconstruction.

If the eigen images E, the transformed data Φ, the kernel matrix α have already been obtained by using the training data and accumulated in one of the PC 501 and the storage 503, subsequent steps S213 and S214 need not to be performed. In other words, once a constant matrix (eigen image and the matrix V in Expression (9)) is generated from the training data, the reconstruction is completed by performing a series of calculations at S215 and subsequent steps even when the unknown sample 203 and the evaluation image change as long as there is no change in the image pickup apparatus 10.

At S213, the kernel matrix α is generated based on Expression (4) or (3) by using the sample data. At S214, the eigen images E are generated based on Expression (5).

At S215 (a first step, a first function), the combination coefficient calculator (first calculator) calculates the linear combination coefficients γ based on Expression (7) or Expression (8).

At S217 (a second step, a second function), the intermediate data generator (second calculator) calculates the intermediate data φ(z) based on Expression (9). At S218 (a third step, a third function), the converter (third calculator) calculates z as the inverse mapping of the intermediate data φ(z).

The reconstruction accuracy may be remarkably degraded depending upon a combination of the unknown sample 203 and the training data. In that case, the norm of γ has an extraordinary value. One solution for this problem is to replace the training data used for reconstruction if the norm of the linear combination coefficients γ calculated at S215 exceeds a threshold. The determiner determines whether the norm of the combination coefficients is equal to or less than a predetermined threshold (S216). This processing method is illustrated by the flowchart in FIG. 3C.

If the norm of the linear combination coefficients γ calculated at S215 exceeds the threshold (NO at S216), the flow proceeds to S219 to replace the training data. More specifically, training data more than T training data used for the reconstruction may be previously prepared, and only T training data may be selected and used for reconstruction. Alternatively, in generating training images through calculations by the imaging simulation, the training images may be generated by newly generating sample data according to predetermined rules. The method of replacing the training data is not limited to these methods.

It is another characteristic of the present invention is that a reconstruction error is predictable during the reconstruction, and an error reduction (by replacing the training data) may be automatically performed when a large error is predicted. This characteristic will be described in detail with a specific example in a third embodiment below.

### First Embodiment

Next follows a description of a first embodiment of the present invention using a numerical simulation.

Simulation conditions will be described below. Illumination light emitted onto a sample from the illumination optical system 100 has a wavelength of 0.55 μm, the imaging optical system 300 has a numerical aperture of 0.70 on a sample side, the illumination optical system 100 has a numerical aperture of 0.49 (or a coherence factor of 0.70).

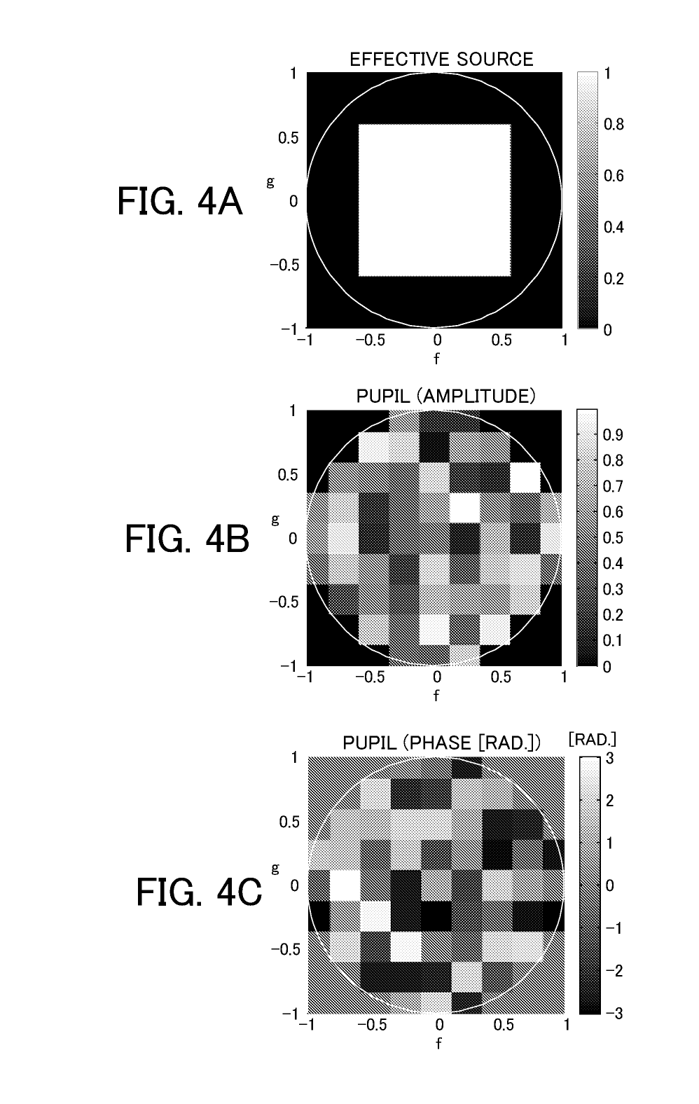

As illustrated in FIG. 4A, the transmitted light intensity distribution on the pupil surface of the illumination optical system (or a light intensity distribution formed on the pupil surface of the imaging optical system in absence of the sample) is uniform inside a circular boundary corresponding to a numerical aperture of 0.49.

FIGS. 4B and 4C illustrate distributions of changes in the amplitude and phase, respectively, of the transmitted light due to the optical element disposed on the pupil surface of the imaging optical system. The amplitude distribution has a uniform random number of 0 to 1 independently generated at each sampling point, and the phase distribution has a Gaussian random number of a standard deviation of 2π radian independently generated at each sampling point. Since an imaging magnification of one means an equal magnification for description convenience, the imaging optical system 300 has a numerical aperture of 0.70 on the image side, and the sample and image plane are equally scaled. Although a real microscope is used at an imaging magnification of several tens to several hundreds, the following discussion is essentially applicable. Since it is known that the bright field microscope is governed by partially coherent imaging, a simulation in this embodiment is performed based on a general two-dimensional partially coherent imaging theory. In addition, assume a dry microscope in which a space between the sample and the imaging optical system 300 is filled with air having a refractive index of 1.00.

Also assume that the conditions described above are unchangeable for subsequent capturing of a training sample and an unknown sample. It is also assumed that a sampling pitch of all samples and images hereinafter is 0.30 μm, the amplitude is a real number from 0 to 1, and the phase is expressed in a radian unit.

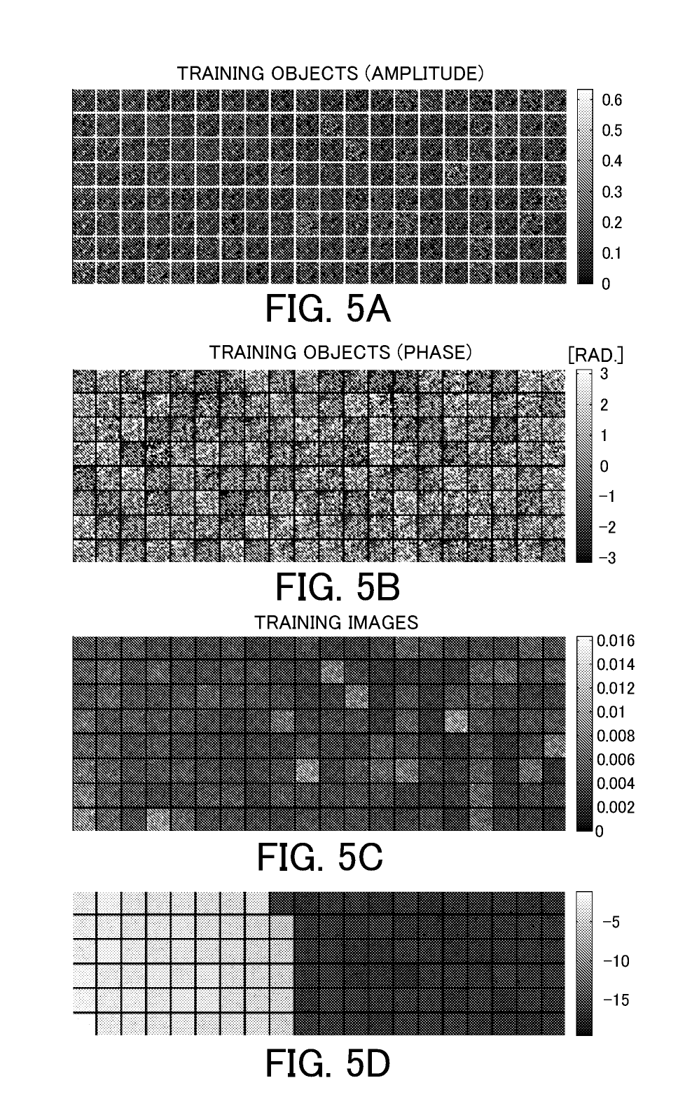

FIGS. 5A and 5B illustrate 160 sample data of amplitudes and phase distributions, each arranged in 8 rows and 20 columns of sets of 11×11 pixels. The respective sample data are apparently dense amplitude and phase distributions generated by vectorizng amplitude and phase distribution at two different apertures with randomly determined transmissivity, phase, and position, and by multiplying them by a binary random matrix.

FIG. 5C similarly illustrates 160 training images (image intensity distributions) calculationally obtained from 160 sample data under the above conditions. A 160×160 kernel matrix is generated from the sample data according to Expression (4), 120 eigenvectors are extracted in descending order of the corresponding eigenvalues, and a 160×120 matrix α is calculated.

According to Expression (5), 120 eigen images are generated from this matrix α and the training images in FIG. 5C. FIG. 5D illustrates the eigen images in 6 rows and 20 columns in common logarithms of their absolute values for better understanding. Eigen images other than 53 images on the left side of FIG. 5D have brightness values equal to or less than 1.00E-10, and the reconstruction accuracy is less affected even if they are not used. This suggests that the number of necessary eigen images L can be determined based on the eigenvalues or eigenvectors of the kernel matrix. Although L equal to or greater than 53 is sufficient in this embodiment, the number of eigen images L is set to 120 for the following calculations.

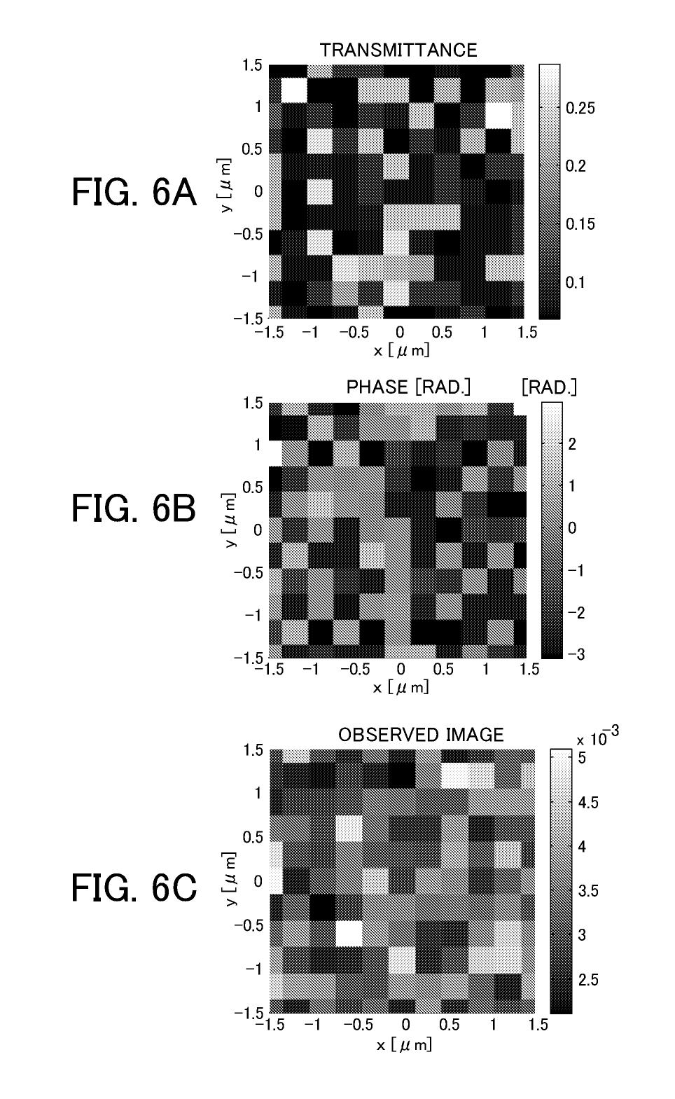

The amplitudes and phase distributions of 11×11 pixels illustrated in FIGS. 6A and 6B, respectively, are set to the unknown sample 203. FIG. 6C illustrates a simulation result of the evaluation image (image intensity distribution) obtained from the unknown sample 203 through the bright field microscope under the above conditions. The figure illustrates an image intensity distribution completely different from that of the sample 203 because of the use of the optical element illustrated in FIGS. 4A-4C.

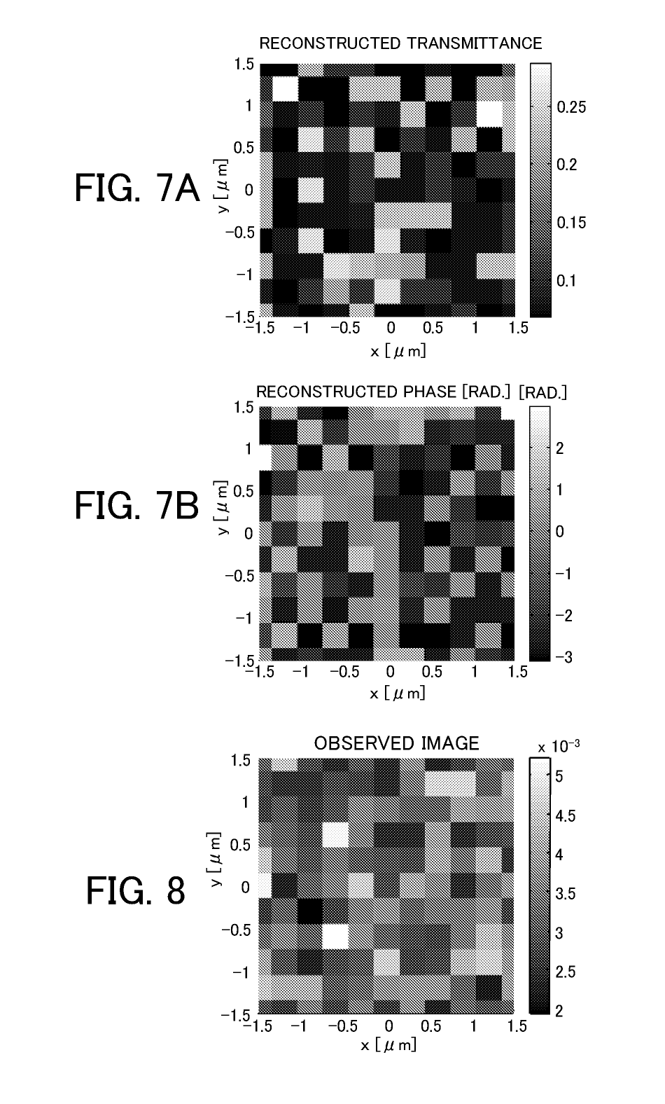

Next, using the training data illustrated in FIGS. 5A-5D, the amplitude and phase distribution of the unknown sample is reconstructed from the evaluation image in FIG. 6C. First, the linear combination coefficients γ are calculated with the regularization parameter λ in Expression (7) set to 0. The linear combination coefficients γ thus obtained are substituted for Expression (9). In addition, the intermediate data φ(z) thus obtained is transformed into a 121×121 matrix, and then receives the singular value decomposition. A product of the square root of the thus-obtained first singular value and the first left singular vector is transformed into an 11×11 matrix, and thus reconstructed amplitude and phase distribution of the unknown sample illustrated in FIGS. 7A and 7B are obtained. These are almost complete reconstructions of the true distributions in FIGS. 6A and 6B. To quantify the reconstructions accuracy, a root mean square error (RMSE) defined by Expression (10) is used.

$$R M S E = \sqrt{\frac{1}{N} {\sum }_{i} {( {x}_{i} - {x}_{i}^{′} )}^{2}} \qquad ( 10 )$$

Herein, N is the number of pixels (121 in this embodiment), i is a pixel number, xᵢ is a reconstructed amplitude or phase of a pixel i, and xᵢ′ is a true amplitude or phase of the pixel i.

The RMSE of FIG. 7A for FIG. 6A is 4.29E-12, and the RMSE FIG. 7B for FIG. 6B is 3.98E-11 radian, which are negligible errors.

Hence, the method according to this embodiment enables a highly accurate reconstruction of the amplitude and phase distribution of the sample 203 only from one evaluation image acquired using the bright field microscope.

The thus reconstructed amplitude and phase distribution can be used for understanding a three-dimensional structure of the unknown sample 203. As a simple example, multiplying the phase distribution by a predetermined constant enables a thickness distribution of a sample having a substantially uniform refractive index to be estimated.

In addition, the use of the amplitude and phase distribution allows unconventional rendering such as rendering of a particular structure within a sample in an enhanced manner, thereby largely extending flexibility in how to show the information of the sample 203.

Since a reconstructed distribution is, in principle, free from influence of image degrading factors of a microscope, a distinct image has a more improved resolving power than that of an image observed using a normal bright field microscope and an observation of a micro structure can be facilitated. The image degrading factors specifically include a blur caused by a diffraction limit of the imaging optical system, and noises and degradations of the resolving power caused by the image sensor.

### Second Embodiment

Next follows a description of a second embodiment according to the present invention using a numerical simulation. All conditions and data except for the observation noises are assumed to be the same as those in the first embodiment.

An additive white Gaussian noise is added as an observation noise to the evaluation image illustrated in FIG. 6C. A noise of each pixel is independent of each other but follows the same statistical distribution that is a normal distribution having an average of 0 and a standard deviation that is 1.00% of a maximum brightness value. In this embodiment, unlike the first embodiment, the reconstruction is based on Expression (7) and the evaluation image illustrated in FIG. 8 to which the observation noise is added.

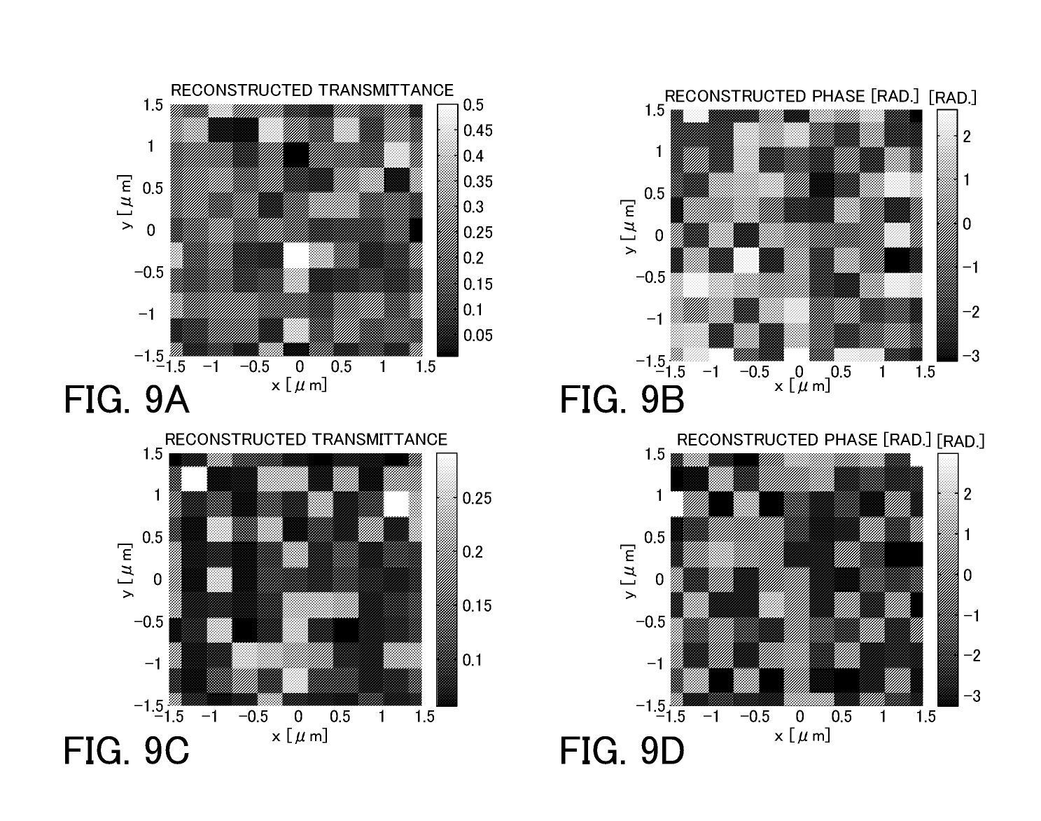

FIGS. 9A and 9B illustrate reconstruction results of the amplitude and phase distribution where the regularization parameter λ in Expression (7) is set to 0 as in the first embodiment. The RMSE of FIG. 9A relative to FIG. 6A is 1.07E-1, and the RMSE of FIG. 9B relative to FIG. 6B is 1.92 radian. FIGS. 9C and 9D illustrate reconstruction results of the amplitude and phase distribution where the regularization parameter λ in Expression (7) is 1.00E-6.

The RMSE of FIG. 9C with respect to FIG. 6A is 7.87E-3, and the RMSE of FIG. 9D with respect to FIG. 6B is 8.18E-1 radian. As clearly understood from the figures and the RMSE values, the distributions subjected to the regularization are closer to the true distributions.

The above results indicate that the regularization in the least squares problem of Expression (6) is effective in suppressing influence of the observation noise. Although this embodiment discusses only the evaluation image to which the observation noise is added, the reconstruction is still viable where the observation noise is added to the training image.

### Third Embodiment

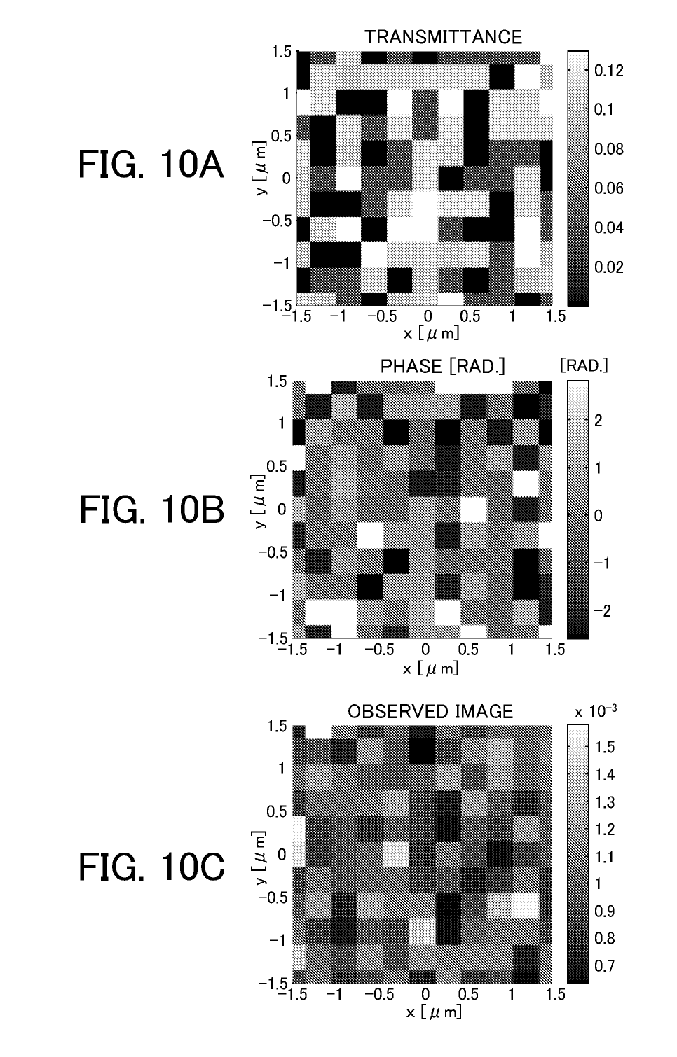

Next follows a description of a third embodiment according to the present invention using a numerical simulation. All the conditions and data except for an unknown sample illustrated in FIGS. 10A-10C are assumed to be the same as those in the first embodiment, and no observation noise is assumed.

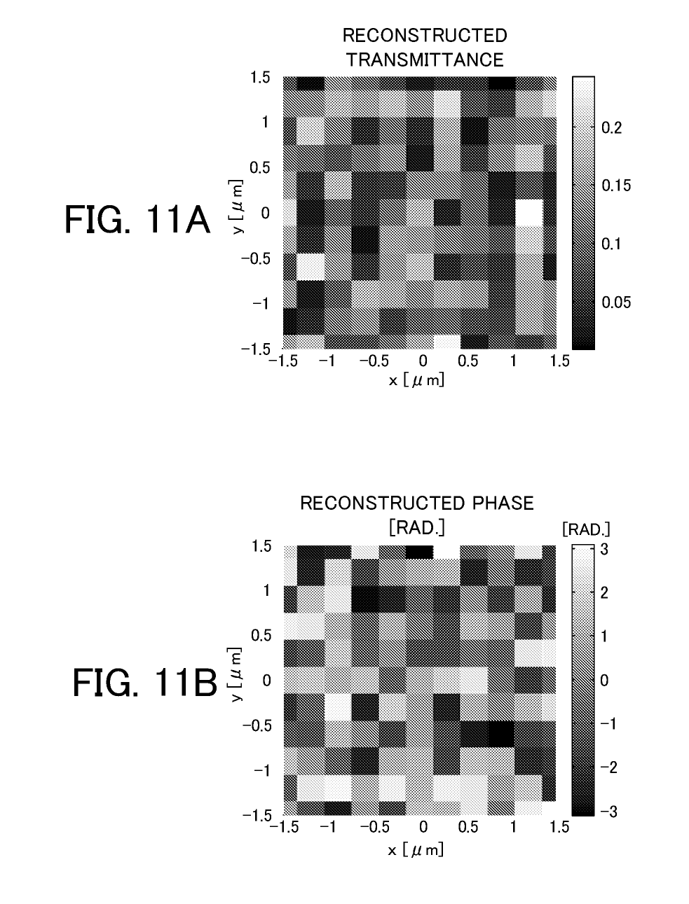

FIGS. 10A and 10B illustrate the amplitude and phase distribution of the unknown sample, and FIG. 10C illustrates the corresponding evaluation image. Since this unknown sample is not consistent with the training data in FIGS. 5A-5D, its reconstruction results are the amplitude and phase distribution illustrated FIGS. 11A and 11B, respectively, which have relatively large errors. The RMSE of FIG. 11A relative to FIG. 10A is 5.76E-2, and the RMSE of FIG. 11B relative to FIG. 10B is 1.47 radian.

Accordingly, the reconstruction is performed in accordance with the flowchart illustrated in FIG. 3C. More specifically, if the L2 norm of γ exceeds a threshold, the reconstruction is halted to replace the training data and is then resumed. Assume that the threshold for the L2 norm of γ is 1.00E+6. In other words, if a determination condition is not satisfied, the determiner replaces a plurality of first samples with other samples and makes the first calculator and the second calculator recalculate the intermediate data. The determination condition in this case is such that the norm of the combination coefficient is equal to or less than the predetermined threshold.

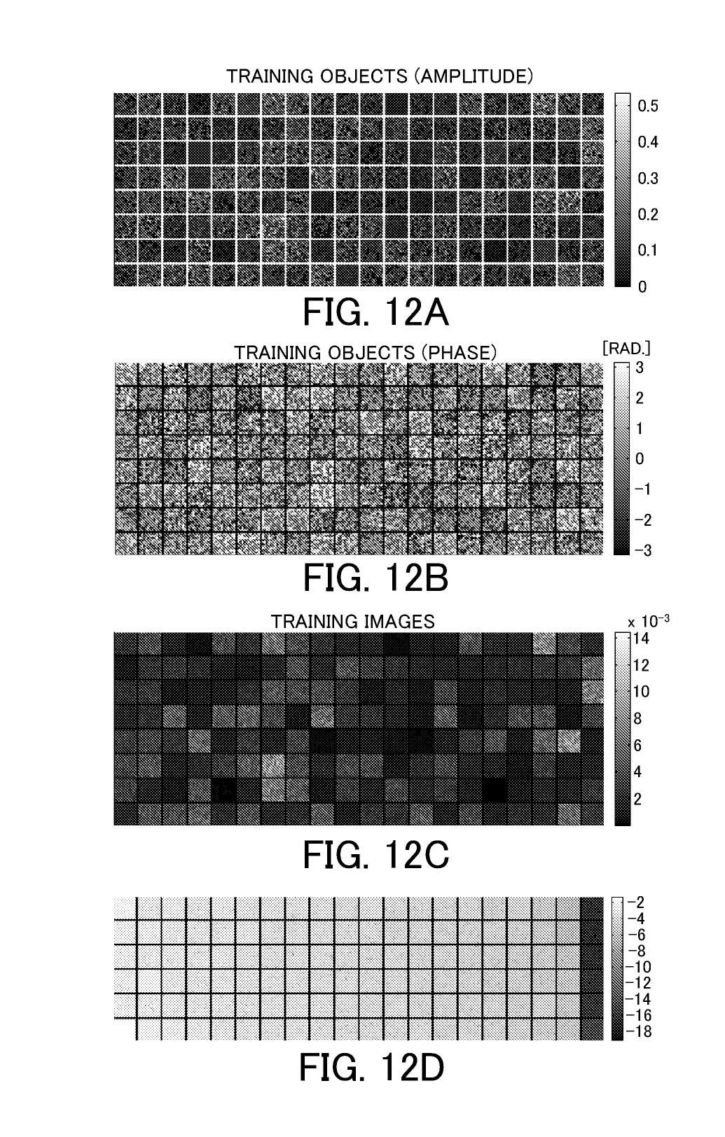

FIGS. 12A-12D illustrate the training data and reconstructed amplitude and phase distribution when the L2 norm of γ is equal to or less than the threshold. The L2 norm of γ is 6.33E+14 for the results in FIGS. 11A and 11B, whereas the L2 norm of γ is 1.08E+4, which is less than the threshold, for the results in FIGS. 12A-12D. Among FIGS. 12A-12D, FIG. 12A illustrates the amplitude distribution of the training sample, FIG. 12B illustrates the phase distribution of the training sample, FIG. 12C illustrates the training images, and FIG. 12D illustrates the eigen images, in the same manner as in FIGS. 5A-5D. Since the training data differs from that in the first embodiment, there are 114 significant eigen images in FIG. 12D except for those in the rightmost column.

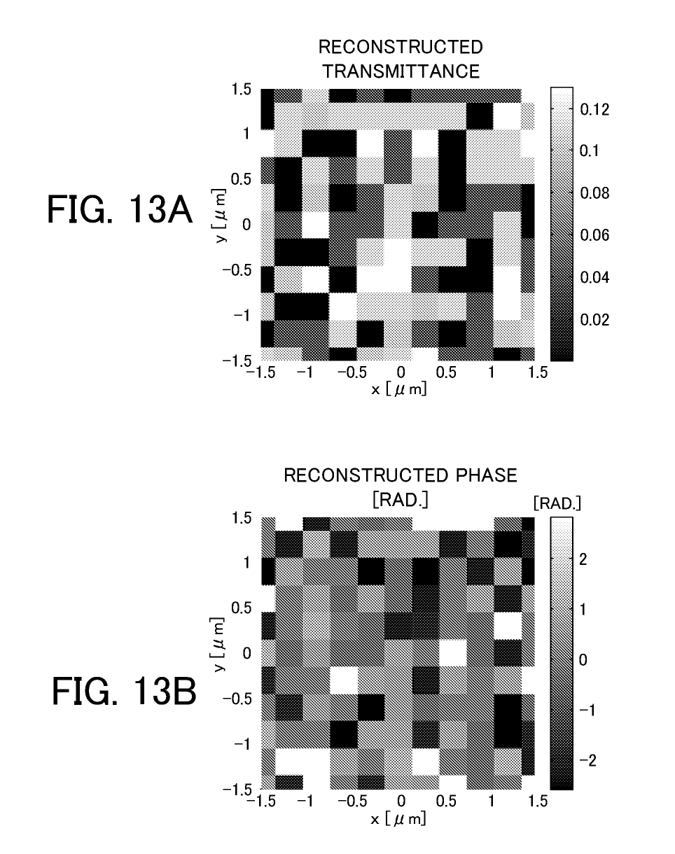

FIGS. 13A and 13B illustrate reconstruction results of the amplitude and phase distribution. The RMSE of FIG. 13A for FIG. 10A is 2.67E-12, and the RMSE of FIG. 13B for FIG. 10B is 4.41E-11 radian, which show an accuracy equivalent to that in Example 1. The above results indicate that the flow illustrated in FIG. 3C is effective in a reliably successful reconstruction, and the reconstruction accuracy is predictable from the value of the L2 norm of γ obtained during the reconstruction.

Each of the above embodiments provides an image processing method, an image processing apparatus, an image pickup apparatus, and a non-transitory computer-readable storage medium that can quickly and highly accurately reconstruct the amplitude and phase distribution of transmitted light of a sample based on an image obtained through a bright field microscope.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-184545, filed Sep. 6, 2013, which is hereby incorporated by reference herein in its entirety.

### REFERENCE SIGNS LIST

10 image pickup apparatus
300 imaging optical system
501 computer (PC)
502 image processor

1. An image processing apparatus comprising:
a first calculator configured to calculate combination coefficients through a linear combination of a basis generated from a plurality of first images that are obtained by photoelectrically converting optical images of a plurality of known first samples formed by a partially coherent or coherent imaging optical system, the combination coefficients being used to approximate a second image;
a second calculator configured to calculate intermediate data based on a plurality of complex quantity data obtained by a non-linear mapping of data of the first samples and the combination coefficients calculated by the first calculator; and
a third calculator configured to calculate complex quantity data of an unknown second sample based on the intermediate data calculated by the second calculator.

2. The image processing apparatus according to claim 1, wherein the second image is obtained by photoelectrically converting an optical image of the second sample formed by the imaging optical system or another imaging optical system having an optical property equivalent to that of the imaging optical system, and the basis is generated as a linear combination of images of the first samples by the first calculator.

3. The image processing apparatus according to claim 2, wherein the first calculator is configured to linearly combine the images of the first samples with linear combination coefficients set to an eigenvector of a kernel matrix defined by using an inner product between complex quantity data corresponding to the first samples.

4. The image processing apparatus according to claim 3, wherein the first calculator determines the number of elements of the basis based on the eigenvalue of the kernel matrix.

5. The image processing apparatus according to claim 2, wherein the first calculator outputs the first images as the basis.

6. The image processing apparatus according to claim 1, wherein the intermediate data is a linear combination of a plurality of matrices obtained from a Kronecker product between a matrix of complex quantities corresponding to the first samples and a complex conjugate to the matrix of the complex quantities.

7. The image processing apparatus according to claim 1, wherein the second image is obtained by photoelectrically converting an optical images of the unknown second sample formed by the imaging optical system or another imaging optical system having an optical property equivalent to that of the imaging optical system.

8. The image processing apparatus according to claim 1, wherein the first images are calculationally generated from the complex quantity data corresponding to the first samples.

9. The image processing apparatus according to claim 1 further comprising a determiner configured to replace, when a determination condition is not satisfied, the first samples with other samples and make the first calculator and the second calculator recalculate the intermediate data.

10. The image processing apparatus according to claim 9, wherein the determination condition is that a norm of the combination coefficients is equal to or less than a predetermined threshold.

11. The image processing apparatus according to claim 1, wherein the first calculator calculates a least squares solution by using a Moore-Penrose pseudo inverse matrix of a matrix including the basis so as to calculate the combination coefficients.

12. The image processing apparatus according to claim 1, wherein the first calculator calculates a least squares solution by performing a Tikhonov regularization so as to calculate the combination coefficients.

13. The image processing apparatus according to claim 12, wherein the first calculator determines a regularization coefficient based on an estimated magnitude of a noise contained in the second image.

14. The image processing apparatus according to claim 1, wherein the third calculator performs a singular value decomposition for a matrix including the intermediate data.

15. An image pickup apparatus comprising:
a partially coherent or coherent the imaging optical system configured to form an optical image of a sample;
an image sensor configured to photoelectrically convert the optical image of the sample formed by the imaging optical system; and
an image processor configured to calculate combination coefficients through a linear combination of a basis generated from a plurality of first images that are obtained by photoelectrically converting optical images of a plurality of known first samples formed by the imaging optical system, the combination coefficients being used to approximate a second image obtained by photoelectrically converting an optical image of an unknown second sample, to calculate intermediate data based on a plurality of complex quantity data obtained by a non-linear mapping of data of the first samples and the combination coefficient that has been calculated, and to calculate complex quantity data of the second sample based on the intermediate data that has been calculated.

16. The image pickup apparatus according to claim 15, wherein the imaging optical system includes, near a pupil plane, an optical element configured to modulate a distribution of at least one of an intensity and phase of light.

17. An image processing method comprising the steps of:
calculating combination coefficients through a linear combination of a basis generated from a plurality of first images that are obtained by photoelectrically converting optical images of a plurality of known first samples formed by a partially coherent or coherent imaging optical system, the combination coefficients being used to approximate a second image;
calculating intermediate data based on a plurality of complex quantity data obtained by a non-linear mapping of data of the first samples and the combination coefficient that has been calculated; and
calculating complex quantity data of an unknown second sample based on the intermediate data that has been calculated.

18. A non-transitory computer-readable storage medium storing a computer program that causes a computer to perform the steps of:
calculating combination coefficients through a linear combination of a basis generated from a plurality of first images that are obtained by photoelectrically converting optical images of a plurality of known first samples formed by a partially coherent or coherent imaging optical system, the combination coefficients being used to approximate a second image;
calculating intermediate data based on a plurality of complex quantity data obtained by a non-linear mapping of data of the first samples and the combination coefficient that has been calculated; and
calculating complex quantity data of an unknown second sample based on the intermediate data that has been calculated.
